(19) United States
(12) Patent Application Publication
(10) Pub. No.: US 2026/0187220 A1
(43) Pub. Date: Jul. 2, 2026

(54) DEVICE TO PERFORM USER AUTHENTICATION

(71) Applicant: Shanghai AVIC Optoelectronics Co., Ltd., Shanghai (CN)

(72) Inventors: Naoyasu IKEDA, Kawasaki (JP); Tetsushi SATO, Kawasaki (JP)

(73) Assignee: Shanghai AVIC Optoelectronics Co., Ltd., Shanghai (CN)

(21) Appl. No.: 19/407,504

(22) Filed: Dec. 3, 2025

(30) Foreign Application Priority Data
Dec. 27, 2024 (JP) 2024-231909

(51) Int. Cl. G06F 21/36; G06F 21/32; G06F 21/40

(52) U.S. Cl. CPC G06F 21/36; G06F 21/32; G06F 21/40

(57) ABSTRACT

A device to perform user authentication includes a controller; and a display device. The controller is configured to display a user authentication image including a plurality of images on the display device. The plurality of images include a to-be selected image for user authentication. Conditions for the user authentication include a condition that the to-be selected image is selected. The to-be selected image satisfies a predetermined to-be selected image condition. The to-be selected image condition specifies a positional relation of the to-be selected image to a neighboring image different from the to-be selected image and satisfying a predetermined neighboring image condition.

### CROSS-REFERENCE TO RELATED APPLICATIONS

This non-provisional application claims priority under 35 U.S.C. §119(a) on Patent Application No. 2024-231909 filed in Japan on December 27, 2024, the entire content of which is hereby incorporated by reference.

### BACKGROUND

This disclosure relates to a device to perform user authentication.

For devices such as smartphones, security locks based on user authentication are known to prevent use by a third person other than the owner. Entering a passcode is a widely known method for unlocking security locks.

The security lock with a passcode can be easily unlocked by someone sneakingly watching the passcode being entered or by using an easy-to-guess passcode. This is because it is known that the passcode as a key is usually a combination of numbers selected from 0 to 9 and it is about four-digit long. Based on this knowledge, if someone remembers the four digits touched when entering them, he or she can unlock the security lock.

This technology of entering numbers as a passcode is widely used in the world. Meanwhile, a technology using a figure as an authentication key, instead of a passcode, is also known. However, like in the case of numbers, the authentication key will also be known by a third person, if he or she peeks at the image at the touch point.

### SUMMARY

An aspect of this disclosure is a device to perform user authentication. The device includes a controller; and a display device. The controller is configured to display a user authentication image including a plurality of images on the display device. The plurality of images include a to-be selected image for user authentication. Conditions for the user authentication include a condition that the to-be selected image is selected. The to-be selected image satisfies a predetermined to-be selected image condition. The to-be selected image condition specifies a positional relation of the to-be selected image to a neighboring image different from the to-be selected image and satisfying a predetermined neighboring image condition.

It is to be understood that both the foregoing general description and the following detailed description are exemplary and explanatory and are not restrictive of this disclosure.

### BRIEF DESCRIPTION OF THE DRAWINGS

FIG. 1 illustrates a configuration example of a user authentication device having a user authentication function.

FIG. 2 schematically illustrates a configuration example of the user authentication device.

FIG. 3 illustrates an example of an image (authentication image) for user authentication in an embodiment of this specification.

FIG. 4 illustrates another example of an authentication image.

FIG. 5 illustrates still another example of an authentication image.

FIG. 6 provides an example of information included in image information stored in the user authentication device.

FIG. 7 is a block diagram illustrating the functional configuration of the user authentication device.

FIG. 8 is a flowchart of an example of authentication image generation processing to be performed by an authentication condition determination unit.

FIG. 9A provides an example of an authentication image satisfying to-be selected image conditions.

FIG. 9B provides an example of a different authentication image satisfying the same to-be selected image conditions as those for FIG. 9A.

FIG. 10 is a flowchart of an example of user authentication processing.

FIG. 11A illustrates an example of a GUI image in a series changing in configuring to-be selected image conditions.

FIG. 11B illustrates an example of a GUI image in a series changing in configuring to-be selected image conditions.

FIG. 11C illustrates an example of a GUI image in a series changing in configuring to-be selected image conditions.

FIG. 11D illustrates an example of a GUI image in a series changing in configuring to-be selected image conditions.

FIG. 11E illustrates an example of a GUI image in a series changing in configuring to-be selected image conditions.

FIG. 11F illustrates an example of a GUI image in a series changing in configuring to-be selected image conditions.

FIG. 11G illustrates an example of a GUI image in a series changing in configuring to-be selected image conditions.

FIG. 11H illustrates an example of a GUI image in a series changing in configuring to-be selected image conditions.

FIG. 12 is a flowchart of an example of the method of configuring to-be selected image conditions for the user authentication related condition generation unit.

FIG. 13 illustrates a configuration example of a user authentication device including a fingerprint sensor.

FIG. 14 illustrates an example of the relation between the sensing region of the fingerprint sensor and the display region.

### EMBODIMENTS

Hereinafter, embodiments will be described with reference to the drawings. Elements common to the drawings are denoted by the same reference signs and some elements in the drawings are exaggerated in size or shape for clear understanding of the description.

For devices such as smartphones, security locks based on user authentication are known to prevent use by a third person other than the owner. Entering a passcode is a widely known method for unlocking security locks.

The security lock with a passcode can be easily unlocked by someone sneakingly watching the passcode being entered or by using an easy-to-guess passcode. This is because it is known that the passcode as a key is usually a combination of numbers selected from 0 to 9 and it is about four-digit long. Based on this knowledge, if someone remembers the four digits touched when entering them, he or she can unlock the security lock.

This technology of entering numbers as a passcode is widely used in the world. Meanwhile, a technology using a figure as an authentication key, instead of a passcode, is also known. However, like in the case of numbers, the authentication key will also be known by a third person, if he or she peeks at the image at the touch point.

An embodiment of this specification describes a technology that makes a user authentication key difficult for a third person to guess when entering the user authentication key to a device having an input function on a screen, such as a smartphone or a tablet terminal.

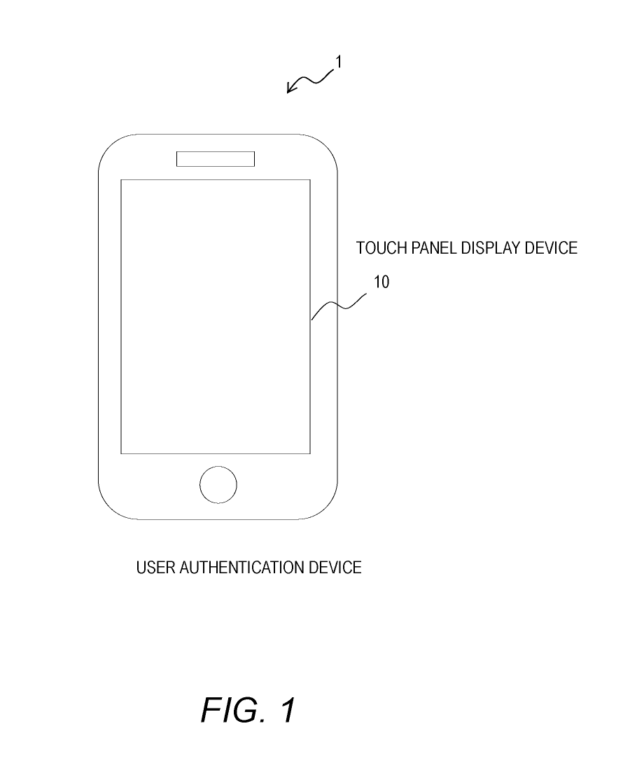

FIG. 1 illustrates a configuration example of a user authentication device 1 having a user authentication function. FIG. 1 provides a smartphone as an example of the user authentication device 1. The user authentication device 1 can be a device of any kind, for example, a smartphone, a tablet terminal, a desk-top computer, or a laptop computer. The user authentication device 1 can be a server computer. For example, the server computer may present a graphical user interface (GUI) for user authentication on a user terminal.

In the example of FIG. 1, the user authentication device 1 includes a touch panel display device 10 of an input device and an output device. The touch panel display device 10 displays an authentication image for user authentication to be described later. The authentication image consists of one or more to-be selected images and the other not-to-be selected images. The to-be selected images are images to be selected to authenticate the user. The user selects images from the authentication image on the touch panel display device 10 with a pointer such as a finger for the user authentication.

The user authentication device 1 determines that the operating user is legitimate if all or some of the to-be selected images are correctly selected from the displayed authentication image in accordance with predetermined authentication conditions. The user authentication can be executed for a user to log in the user authentication device 1 or to switch to a specific application or a specific GUI image.

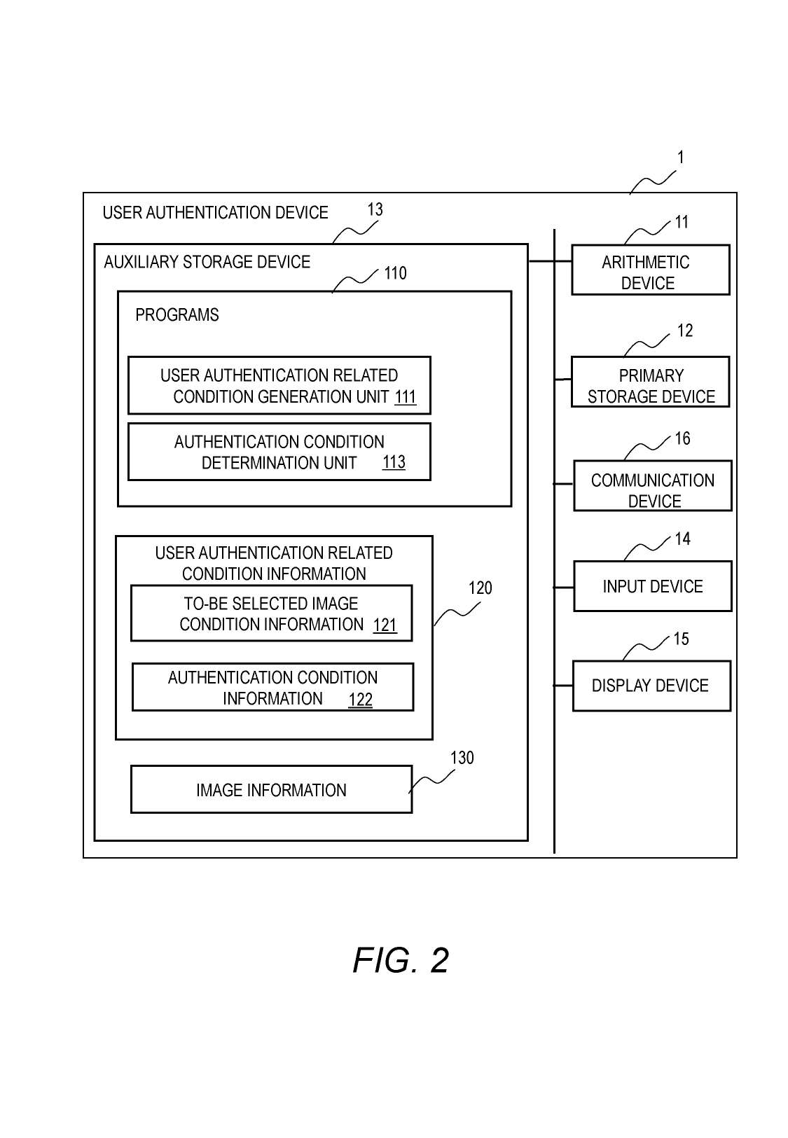

FIG. 2 schematically illustrates a configuration example of the user authentication device 1. The user authentication device 1 can have a computer configuration. In the configuration example in FIG. 2, the user authentication device 1 includes an arithmetic device 11, a primary storage device 12, an auxiliary storage device 13, an input device 14, a display device 15, and a communication device 16. The components except for the input device 14 and the display device 15 are included in a controller of the user authentication device 1.

The auxiliary storage device 13 is a storage device configured of an appropriate non-volatile storage element such as a solid-state drive (SSD) or a hard disk drive (HDD). The primary storage device 12 is a storage device configured of a volatile storage element such as a random-access memory (RAM). Either one of the auxiliary storage device 13 and the primary storage device 12 or the combination thereof is a storage device.

An example of the arithmetic device 11 is a central processing unit (CPU). The arithmetic device 11 retrieves programs 110 stored in the auxiliary storage device 13 into the primary storage device 12 and executes them to control the overall user authentication device 1 and to perform a variety of determination, arithmetic operation, and control.

The arithmetic device 11 works as a function unit (means) to implement a predetermined function by executing a program stored in the primary storage device 12. The arithmetic device 11 can include a plurality of chips and a plurality of packages. A program is executed by the arithmetic device 11 to perform predetermined processing with the storage device and the communication device. Accordingly, a description having a subject of a program may be replaced by a description having a subject of the arithmetic device 11 or the computer or the computer system running the program.

At least a part of the function implemented by a program can be implemented by dedicated hardware. A program can be installed to the device through a program distribution server or a computer-readable non-transitory storage medium and can be stored in a non-volatile storage device.

The input device 14 is a device for entering user input from the external to the user authentication device 1, such as a touch panel, a keyboard, and a mouse. The input device 14 forwards information of the user input to the arithmetic device 11. In an embodiment of this specification, the input device forwards information of user input for generating an authentication image and user input for user authentication to the arithmetic device 11.

The display device 15 displays images generated by the arithmetic device 11. The display device 15 can be a liquid crystal display device or an organic EL display device, for example. In an embodiment of this specification, the display device 15 displays a GUI image for generating an authentication image for user authentication or the authentication image in user authentication. The communication device 16 is a network interface that connects to a network to communicate with other devices.

One or more of the components shown in FIG. 2 can be excluded. For example, in the case where the user authentication device 1 is a server computer to be accessed from a user terminal, the input device 14 and the display device 15 can be excluded. If the user authentication device 1 does not need communication with other devices, the communication device 16 can be excluded.

The auxiliary storage device 13 stores programs 110 to implement functions necessary for the user authentication device 1. The programs 110 include a not-shown operating system and further, a user authentication related condition generation unit 111 and an authentication condition determination unit 113. The auxiliary storage device 13 still further stores a user authentication related condition information 120 and image information 130.

The user authentication related condition information 120 includes to-be selected image condition information 121 and authentication condition information 122. The image information 130 stores data to be used to generate a plurality of images to be included in an authentication image. The image information 130 includes parameters and image data for generating images to be included in an authentication image, such as letters, figures, patterns, colors, and photos.

The to-be selected image condition information 121 defines conditions for the images to be selected by the user in an authentication image. The authentication condition information 122 defines conditions on the images to be selected from the authentication image to authenticate the user. For example, the authentication condition information 122 defines the number of images to be selected from one or more images included in an authentication image to authenticate the user, the number of successive tries to be allowed, and a time-out duration.

The to-be selected image condition information 121 and the authentication condition information 122 are generated by the user authentication related condition generation unit 111 in accordance with user input. The authentication condition determination unit 113 executes user authentication using an authentication image. More specifically, the authentication condition determination unit 113 generates and displays an authentication image in accordance with the to-be selected image condition information 121 and further, determines whether the accessing user is a legitimate user based on the user input onto the authentication image and the authentication condition information 122.

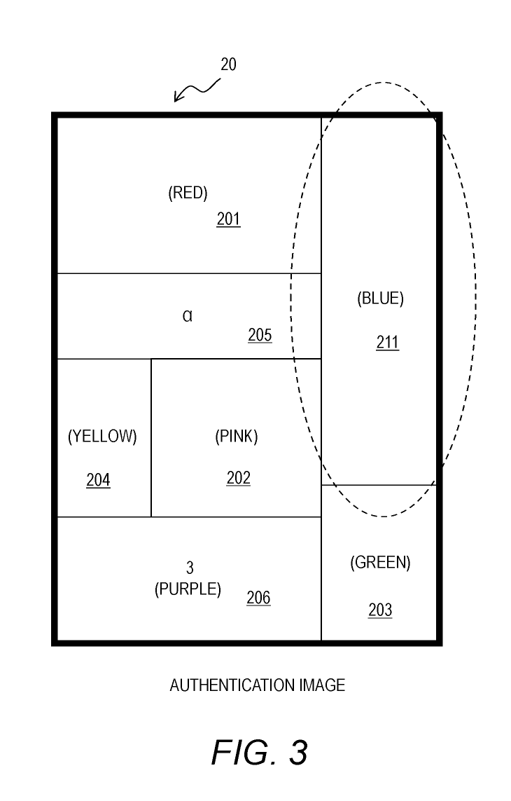

FIG. 3 illustrates an example of an image (authentication image) for user authentication in an embodiment of this specification. The authentication image 20 consists of a plurality of rectangular images 201 to 206 and 211. The image 211 is a to-be selected image and the other images 201 to 206 are not-to-be selected images.

In FIG. 3, a word in brackets “( )” indicates the color of the image and a character without brackets is the character included in the image. For example, the images 201 to 204 are images of red, pink, green, and yellow rectangles and the to-be selected image 211 is an image of a blue rectangle. The image 205 is an image of a rectangle including a character of “α”. The image 206 is an image of a purple rectangle including a character of “3". The color of the image 205 for which the color is not specified in FIG. 3 is a default color, for example, white.

The to-be selected image condition defined for the example of the authentication image 20 in FIG. 3 is “an image in contact with a red image and a green image”. In the authentication image 20, only the to-be selected image 211 satisfies this to-be selected image condition. In other words, only the to-be selected image 211 is in contact with a red image 201 and a green image 203. Meanwhile, the condition to authenticate the user is that the user selects all to-be selected images 211 before a timeout.

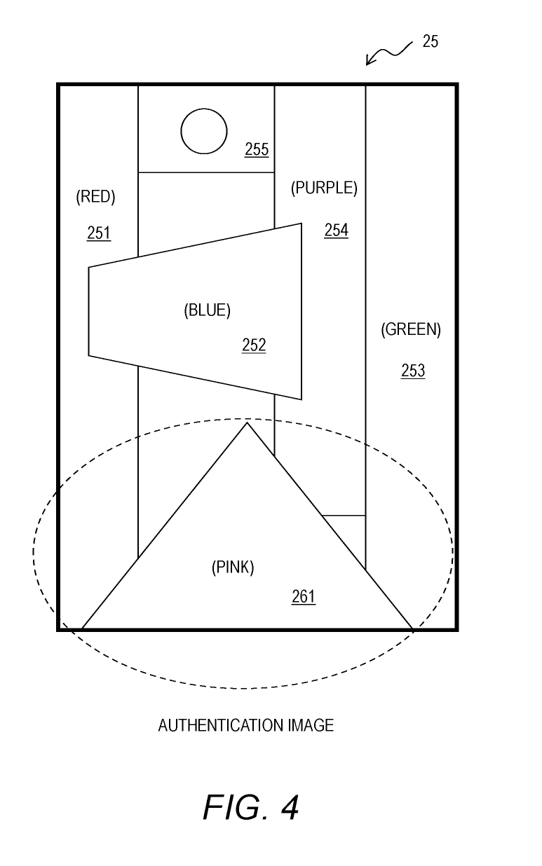

FIG. 4 illustrates an authentication image 25 as another example. The to-be selected image condition for the authentication image 25 defined in the to-be selected image condition information 121 is the same as the to-be selected image condition for the authentication image 20 in FIG. 3. The authentication condition for the authentication image 25 defined in the authentication condition information 122 is the same as the authentication condition for the authentication image 20 in FIG. 3.

The authentication image 25 consists of a plurality of images 251 to 255 and 261. The region other than the images 251 to 255 and 261 is a background region of the authentication image 25. The images 251, 252, 253, and 254 are a red image, a blue image, a green image, and a purple image, respectively. The image 255 is an image of a rectangle including a circle therein. The image 261 is a to-be selected image and it is a pink image.

The authentication image 25 includes a plurality of overlaid images. The blue trapezoidal image 252 is displayed in such a manner that some parts of the image 252 are located on top of the rectangular images 251 and 254 and the pink triangular image 261 is displayed in such a manner that some parts of the image 261 are located on top of the rectangular images 251, 253, and 254. When the authentication image 25 is displayed, the images 251, 253, and 254 look as polygons different from rectangles.

Like this example, each image in an authentication image can have a different shape and a different size and it can be disposed to overlap with one or more images or not to overlap with any images.

The to-be selected image condition defined for the authentication image 25 is “an image in contact with a red image and a green image”, like the one for the authentication image 20 in FIG. 3. In the authentication image 25, only the pink image 261 satisfies this to-be selected image condition. In other words, only the to-be selected image 261 is in contact with the red image 251 and the green image 253. The condition to authenticate the user is that the user selects all to-be selected images 261 before a timeout. Selecting an image can be done by using input from a touch panel, a mouse, or a keyboard or using an analysis result of a speech or a line of sight captured by a camera.

As described with reference to FIGS. 3 and 4, an authentication image consists of a plurality of images (displayed images) including one or more to-be selected images. As will be described later, a one time of user authentication processing can present a plurality of authentication images one after another and some of the authentication images do not have to include a to-be selected image. The examples described with reference to FIGS. 3 and 4 include a single to-be selected image.

The to-be selected image conditions for a to-be selected image include information about a region other than the to-be selected image. In an embodiment of this specification, the to-be selected image conditions include a positional relation of the to-be selected image and a neighboring image. A neighboring image is an image different from the to-be selected image and it is another to-be selected image or a not-to-be selected image. Neighboring image conditions defining a neighboring image are included in the to-be selected image conditions. In the examples described with reference to FIGS. 3 and 4, a neighboring image condition is that the image is a red or green image and a to-be selected image condition defines that the to-be selected image is in contact with a red image and a green image. The images other than the to-be selected image do not satisfy the to-be selected image conditions.

The user authentication device 1 dynamically determines the position and/or the attributes of the to-be selected image without fixing them in generating an authentication image. That is to say, at least one of the shape, size, category, element in the category (these are included in attributes), and position of the to-be selected image is variable. Although the to-be selected image conditions are common to the examples described with reference to FIGS. 3 and 4, the positions, colors, and shapes of the to-be selected images 211 and 261 are different. Changing the manner of display (including the position and attributes) of the to-be selected image among the authentication images like these examples reduces the possibility for the third person to know the to-be selected image and improves the security.

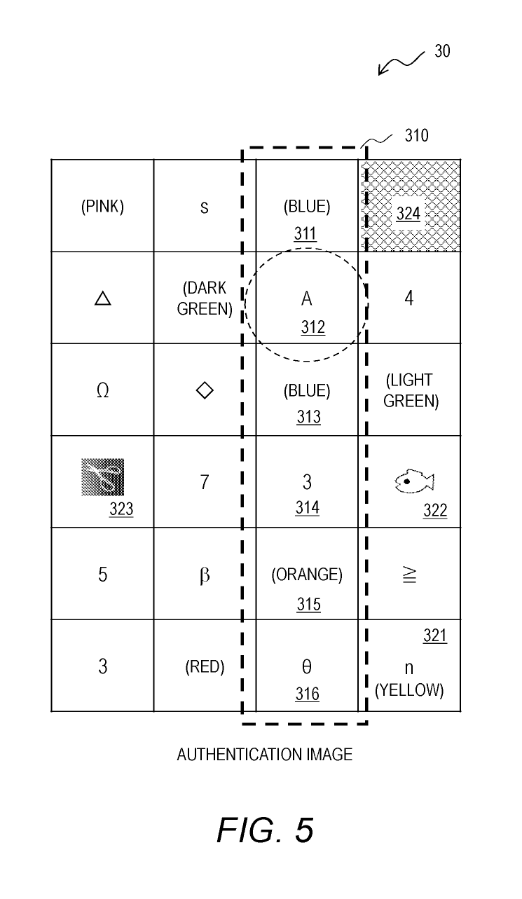

FIG. 5 illustrates an authentication image 30 as still another example. Compared to the example described with reference to FIG. 3 or FIG. 4, the authentication image 30 consists of a plurality of images disposed in a matrix. That is to say, the relative positions of the images are fixed in the authentication image 30. In the example of FIG. 5, each image is framed by a rectangle.

In the example of FIG. 5, the authentication image 30 consists of images in six rows by four columns. Each image can have one or more attributes. For example, the image 311 only shows blue color and the image 321 shows a letter “n” and yellow color. The image 322 shows a figure of a fish and the image 323 shows a photo of scissors. The image 324 shows a specific pattern.

The to-be selected image condition defined for the authentication image 30 is “an image including a letter or a number in the second row from the top in the column including three images having a color”. The condition to authenticate the user is that the user selects all to-be selected images before a timeout.

In FIG. 5, the word in brackets “( )” indicates the color of the image and the element without brackets means the element shown in the image, like those in FIGS. 3 and 4. The images without a color in brackets are in a default color (e.g., white), which is defined as no color.

With reference to FIG. 5, the image 312 in the column 310 satisfies the above to-be selected image condition. Specifically, the column 310 consists of images 311 to 316. The image 311 only shows blue color. The image 312 only shows a letter “A”. The image 313 only shows blue color. The image 314 only shows a number “3”. The image 315 only shows orange color. The image 316 only shows a letter “θ”.

In the column 310, the images having an attribute of color are three images of the blue images 311 and 313 and the orange image 315. The other columns do not satisfy this condition. For example, the leftmost column includes only one image having an attribute of color and the rightmost column includes two images having an attribute of color.

In the column 310, the second image 312 from the top shows a letter “A”. Accordingly, the image 312 is the to-be selected image. In the authentication image 30 in FIG. 5, the to-be selected image is only the image 312.

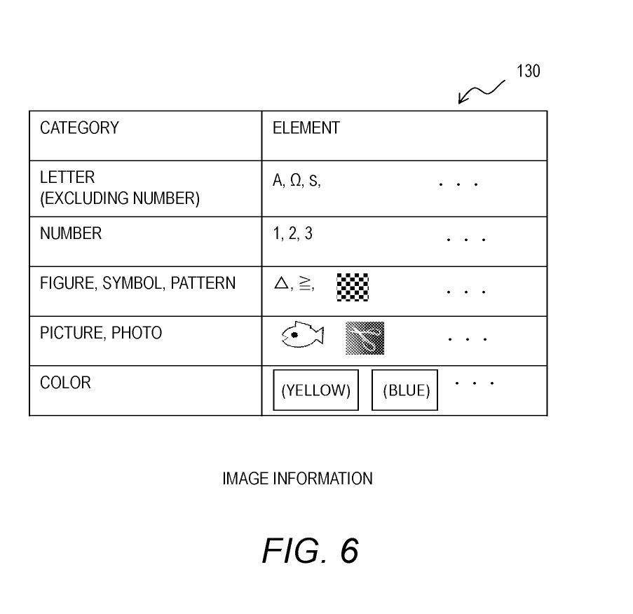

FIG. 6 provides an example of information (data) included in the image information 130 stored in the user authentication device 1. The image information 130 includes information to generate and display images in an authentication image. In the example of FIG. 6, the image information 130 defines categories to which images belong. The image information 130 provides categories of images to be used in an authentication image and images (elements) included in each category.

The categories of images to be used in an authentication image can include letter (excluding number), number, figure, symbol, pattern, picture, photo, color, and the like. In the example in FIG. 6, the figure, symbol, and pattern are included in the same category and the picture and photo are included in the same category. The categories shown in FIG. 6 are merely examples; one or more of them can be excluded and one or more other categories can be included. The image information does not need to define the categories of images.

In the examples described with reference to FIGS. 3, 4 and 5, the authentication image is a combination of images and one or more of the images can be to-be selected images. The to-be selected image conditions include information on other images. The user authentication device 1 disposes a to-be selected image at a position satisfying the to-be selected image conditions and disposes not-to-be selected images so that they do not satisfy the to-be selected image conditions. The user authentication related condition information 120 can be configured by the user to be authenticated or another user.

The position of the to-be selected image in the authentication image is not fixed; authentication information is not included at an absolute position in the authentication image. Since the category of the to-be selected image can be changed among letter, symbol, picture, photo, and others, the authentication information is not included in the category or element of an image. As noted from this description, the manner of display (including the attributes and the positions) of the to-be selected image and the other images is determined differently depending on the authentication image; accordingly, leakage of authentication information to other people can be effectively prevented.

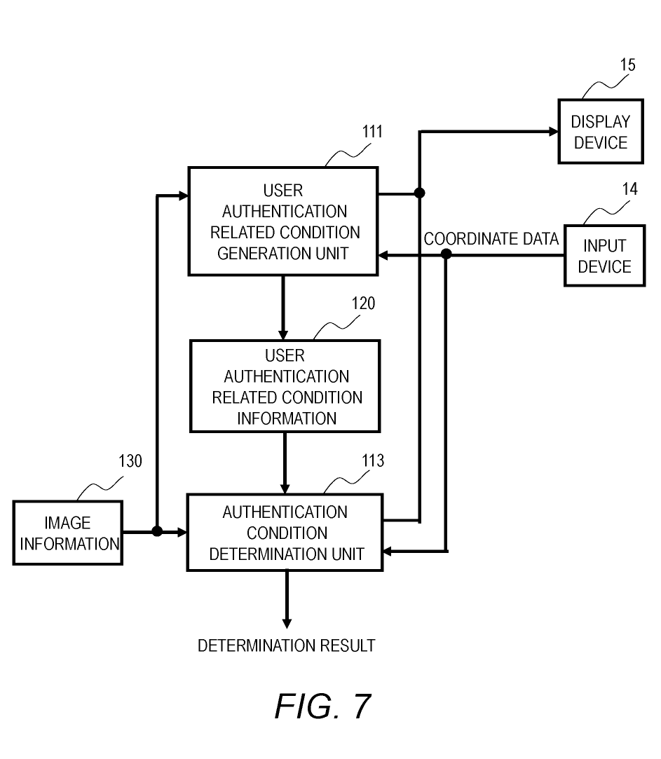

Hereinafter, the processing of the user authentication device 1 is described. FIG. 7 is a block diagram illustrating the functional configuration of the user authentication device 1. The user authentication related condition generation unit 111 receives to-be selected image conditions and authentication conditions input by the user through the GUI of the display device 15 and the input device 14 and stores them to the user authentication related condition information 120.

The authentication condition determination unit 113 generates an authentication image from the image information 130 with reference to the to-be selected image condition information 121 in the user authentication related condition information 120 and displays the authentication image on the display device 15. Furthermore, the authentication condition determination unit 113 acquires user input to the authentication image from the input device 14 and determines whether the user is legitimate.

First, the processing of the authentication condition determination unit 113 is described. The authentication condition determination unit 113 generates an authentication image from the image information 130 based on the to-be selected image condition information 121 and displays the authentication image on the display device 15. The authentication condition determination unit 113 also determines whether user input from the input device 14 (e.g., a user’s touch operation on a touch panel) satisfies the to-be selected image conditions and the authentication conditions specified in the user authentication related condition information 120 and outputs a determination result.

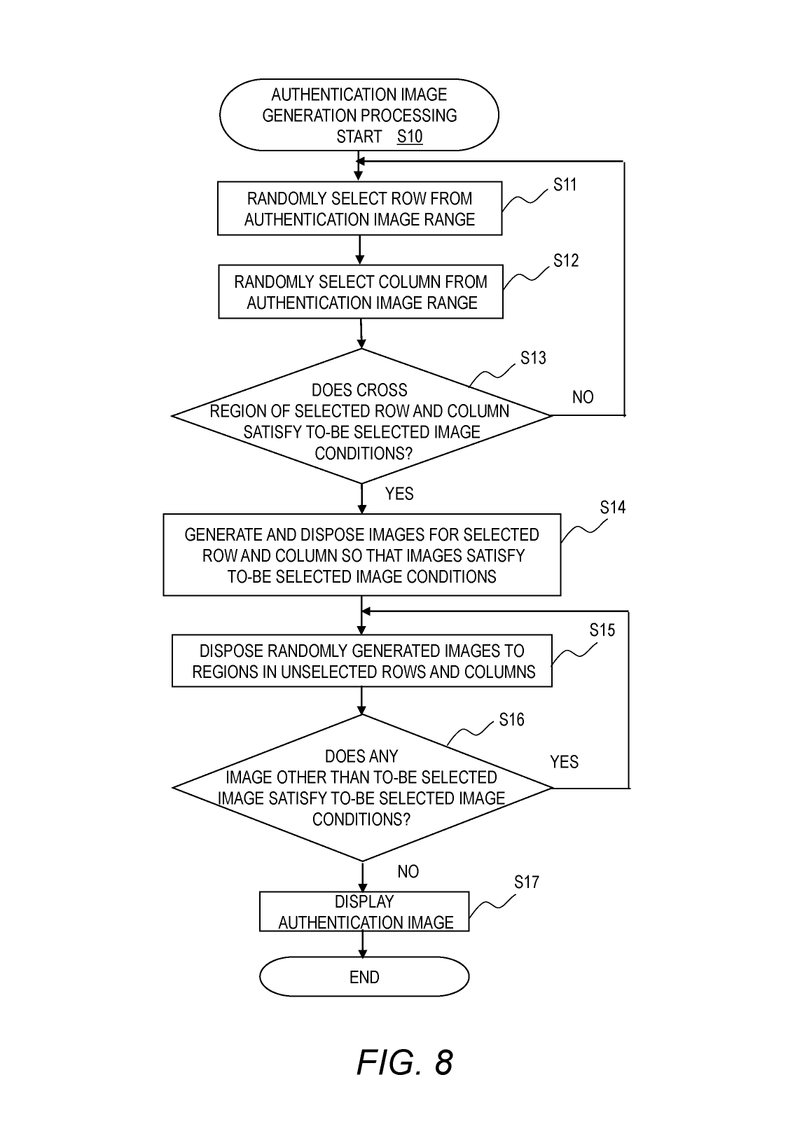

FIG. 8 is a flowchart of an example of authentication image generation processing S10 to be performed by the authentication condition determination unit 113. Assume that the authentication image here consists of images disposed in a matrix and the authentication image includes one to-be selected image.

The authentication condition determination unit 113 starts the authentication image generation processing S10 in response to a control signal from another function unit. For example, a contact to the touch panel of the user authentication device 1 in a locked state or an access to a specific site can be a trigger.

The authentication condition determination unit 113 randomly selects a row from the range specified for an authentication image (S11). The number of rows and columns for an authentication image is predetermined. Further, the authentication condition determination unit 113 randomly selects a column from the range specified for an authentication image (S12).

Next, the authentication condition determination unit 113 determines whether the position of the cross region of the selected row and the selected columns satisfies the to-be selected image conditions specified in the to-be selected image condition information 121 (S13). If the position does not satisfy the to-be selected image conditions (S13: NO), the processing returns to Step S11. If the position satisfies the to-be selected image conditions (S13: YES), the processing proceeds to the next Step S14. If the to-be selected image conditions do not specify the position of the to-be selected image, the authentication condition determination unit 113 determines the given position satisfies the to-be selected image conditions.

Taking the example of the authentication image 30 in FIG. 5, the to-be selected image condition for the authentication image 30 is “an image including a letter or a number in the second row from the top in the column including three images having a color”. Accordingly, if the cross region of the selected row and column is included in the second row from the top, the condition on the position of the to-be selected image is satisfied.

Next, the authentication condition determination unit 113 generates and disposes images for the selected row and/or column so that the images including the images in the intersecting areas of the selected rows and columns satisfy the to-be selected image conditions (S14). For example, the authentication condition determination unit 113 generates an image having the attribute specified in the to-be selected image condition information 121 and disposes the generated image to the above-described cross region. Furthermore, the authentication condition determination unit 113 generates and disposes images for the row and/or column so that the images satisfy the conditions defined in the to-be selected image condition information 121.

Step S14 is explained using the authentication image 30 in FIG. 5 as an example. As described above, the to-be selected image condition for the authentication image 30 is “an image including a letter or a number in the second row from the top in the column including three images having a color”. The authentication condition determination unit 113 selects a letter or a number for the to-be selected image 312 from the image information 130. The color may be selected if the condition for the color is defined.

Furthermore, the authentication condition determination unit 113 determines the attributes for the other images in the column 310 including the to-be selected image 312. The authentication condition determination unit 113 randomly selects three image regions except for the image region for the to-be selected image 312 from the column 310 and selects a color and an element other than the color (such as a letter or a symbol) for each image region from the image information 130. Still further, the authentication condition determination unit 113 determines that the color of the images in the remaining image regions is to be no color (the default color) and randomly selects elements except for colors to be displayed in the images. The attributes of the remaining images in the row including the to-be selected image 312 can be determined randomly.

After determining the images for the selected row and column, the authentication condition determination unit 113 randomly generates images for the remaining image regions and disposes them (S15). Next, the authentication condition determination unit 113 determines whether any image other than the to-be selected image satisfies the to-be selected image conditions (S16). If any of the not-to-be selected images satisfies the to-be selected image conditions (S16: YES), the processing returns to Step S15. If none of the not-to-be selected images satisfy the to-be selected image conditions (S16: NO), the authentication condition determination unit 113 displays the generated authentication image on the display device 15.

The example described with reference to FIG. 8 disposes only one to-be selected image in an authentication image. In the case of disposing a plurality of to-be selected images, the authentication condition determination unit 113 can repeat Steps S11 to S14 for the times as many as the number of to-be selected images and then execute Steps S15 to S17.

An authentication image in which images are disposed in a non-matrix layout as described with reference to FIG. 3 or FIG. 4 can be generated as follows. The authentication condition determination unit 113 randomly determines where to place the to-be selected image in the authentication image and determines the attributes for the to-be selected image from the image information 130 in accordance with the to-be selected image conditions. Since the to-be selected image conditions for the authentication image 20 in FIG. 3 do not specify the attributes for the to-be selected image, the authentication condition determination unit 113 can randomly determine the attributes. For the example of FIG. 3, the authentication condition determination unit 113 determines the position and the shape of the image 211 and further determines that the element to be displayed is only blue color.

Next, the authentication condition determination unit 113 determines the positions and attributes of the neighboring images satisfying the neighboring image conditions in the to-be selected image conditions. For the authentication image 20 in FIG. 3, the red image 201 and the green image 203 are generated and they are disposed to be in contact with the to-be selected image 211. The attributes and the positions for the other images can be determined randomly. If any of the images other than the to-be selected image satisfies the to-be selected image conditions, the authentication condition determination unit 113 randomly determines the attributes and the positions for the other images again. This step is repeated until all the images other than the to-be selected image get out of the to-be selected image conditions.

Likewise for the authentication image 25 in FIG. 4, the authentication condition determination unit 113 can determine the attributes and the position for the to-be selected image and then determine the attributes and positions satisfying the to-be selected image conditions (the neighboring image conditions therein) for the neighboring images. In the case where a plurality of to-be selected images are to be disposed, the authentication condition determination unit 113 repeats the foregoing steps. Subsequently, the authentication condition determination unit 113 can randomly determine the attributes and the positions for the other images. The authentication condition determination unit 113 repeats the random selection for the other images until all the randomly determined images get out of the to-be selected image conditions.

The foregoing methods of generating an authentication image are examples; the authentication condition determination unit 113 can employ any method or algorithm to generate an authentication image including a predetermined number of to-be selected images satisfying to-be selected image conditions. In another example, the limitation on the number of to-be selected images in an authentication image can be excluded; one authentication image can include any number of to-be selected images. The authentication conditions can include a condition that 50% or more of those to-be selected images need to be selected.

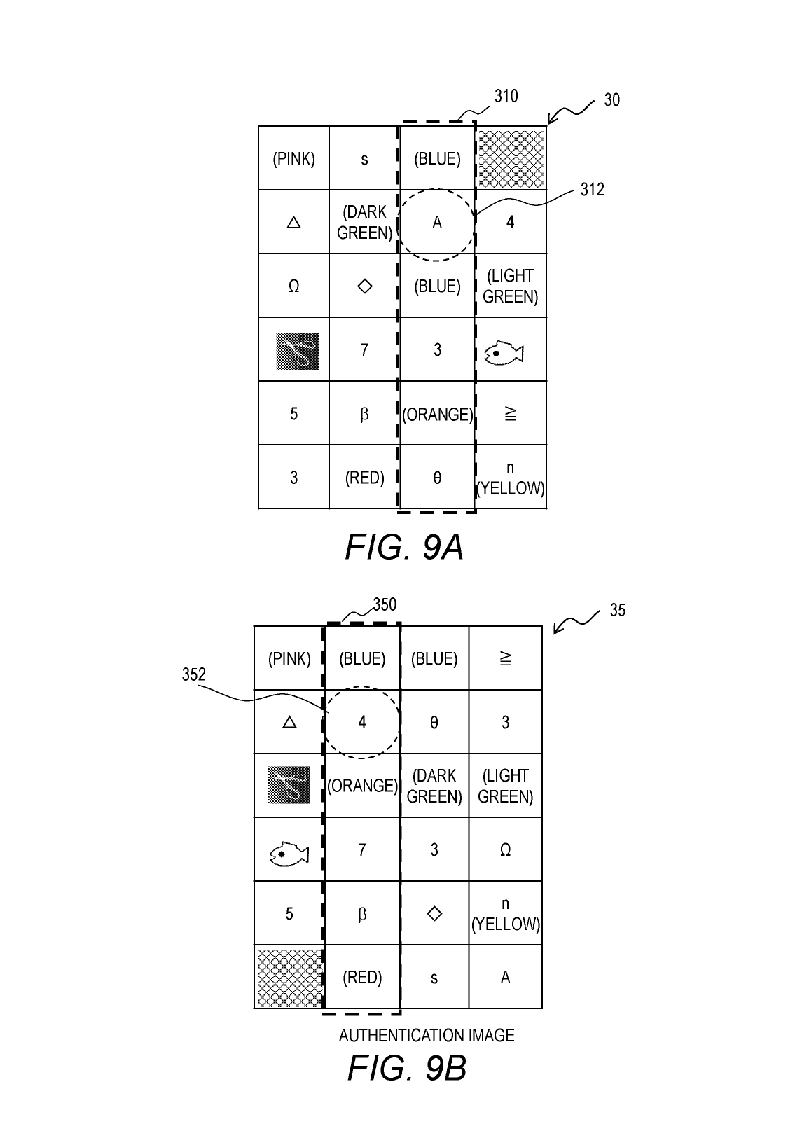

FIGS. 9A and 9B provide examples of different authentication images satisfying the same to-be selected image conditions. The authentication image 30 in FIG. 9A is identical to the authentication image 30 in FIG. 5. The authentication image 35 in FIG. 9B is an image satisfying the same to-be selected image conditions as those for the authentication image 30 but being different from the authentication image 30. As described above, the to-be selected image condition for the authentication image is “an image including a letter or a number in the second row from the top in the column including three images having a color”.

The to-be selected image 312 in the authentication image 30 in FIG. 9A is an image (region) 312 including a letter “A” in the second row from the top and the third column 310 from the left. The to-be selected image 352 in the authentication image 35 in FIG. 9B is an image (region) 352 including a number “4” in the second row from the top and the second column 350 from the left.

As understood from these examples, the authentication condition determination unit 113 can generate different authentication images satisfying the same to-be selected image conditions. This configuration improves the security in user authentication. The method described with reference to FIG. 8 randomly determines the position and the attributes of the to-be selected image and the positions and the attributes of the not-to-be selected images within the range satisfying the to-be selected image conditions. All or some of these images can be determined by another method, for example a round-robin, and some of these images can be fixed.

The image information 130 can include information of candidate images as many as or more than the images to be included in one authentication image. Selecting images for an authentication image from a number of images more than the images to be included in the authentication image leads to reducing the number of times for the same image to be used repeatedly, improving the security in user authentication.

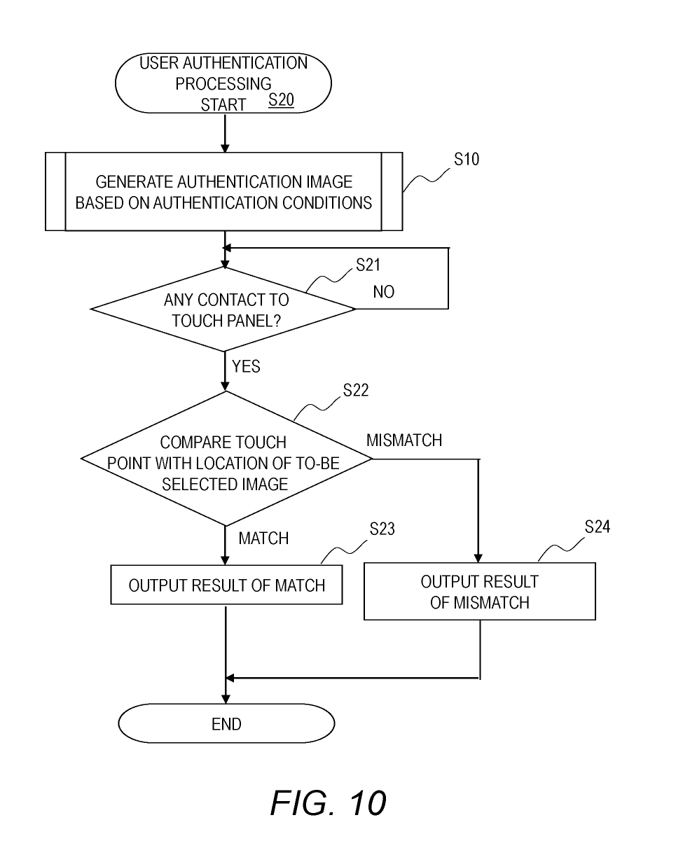

Next, the processing S20 of determining whether the user is legitimate based on user operation on an authentication image is described. FIG. 10 is a flowchart of an example of the user authentication processing. The description here is provided assuming that the user selects a to-be selected image from an authentication image on a touch panel and one to-be selected image needs to be selected from the authentication image.

After the authentication image generation processing S10, the authentication condition determination unit 113 determines whether the touch panel is contacted by a user (S21). A not-shown touch panel controller performs touch sensing on the touch panel. The authentication condition determination unit 113 receives a touch sensing result indicating a touch point.

If a contact to the touch panel is detected (S21: YES), the authentication condition determination unit 113 compares the touch point with the location of the to-be selected image (S22). The location of the to-be selected image can be any point in the region inner than the outline of the image.

If the touch point matches the location of the to-be selected image, or the touch point is included in the region of the to-be selected image (S22: MATCH), the authentication condition determination unit 113 outputs a result indicating it to another program (S23). The other program can display an initial image after the user logs in. If the touch point does not match the location of the to-be selected image, or the touch point is outside the region of the to-be selected image (S22: MISMATCH), the authentication condition determination unit 113 outputs an image indicating it to the display device 15. The determination result can also be output to the other program.

Hereinafter, configuring the user authentication related condition information 120 is described. The user authentication related condition generation unit 111 determines to-be selected image conditions and authentication conditions in accordance with user input and stores information on them to the to-be selected image condition information 121 and the authentication condition information 122. In the example described in the following, the user to be authenticated inputs information on the user authentication related conditions. The user to input the information can be a system administrator.

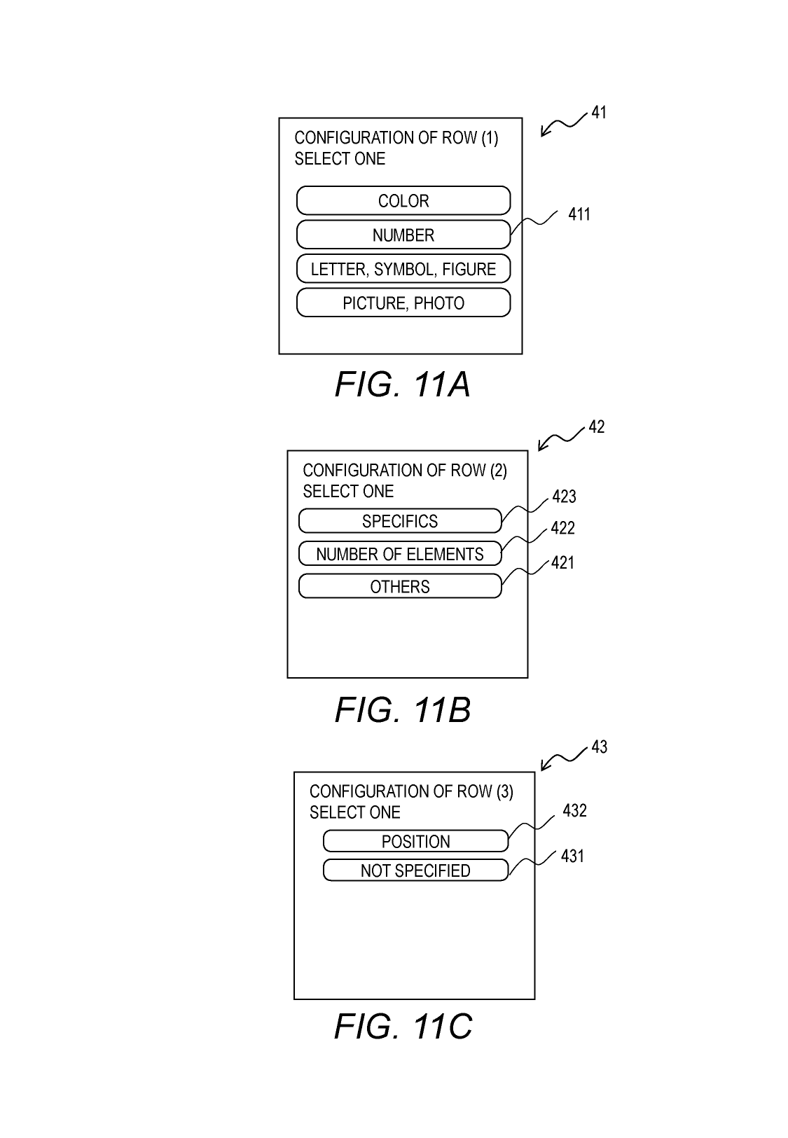

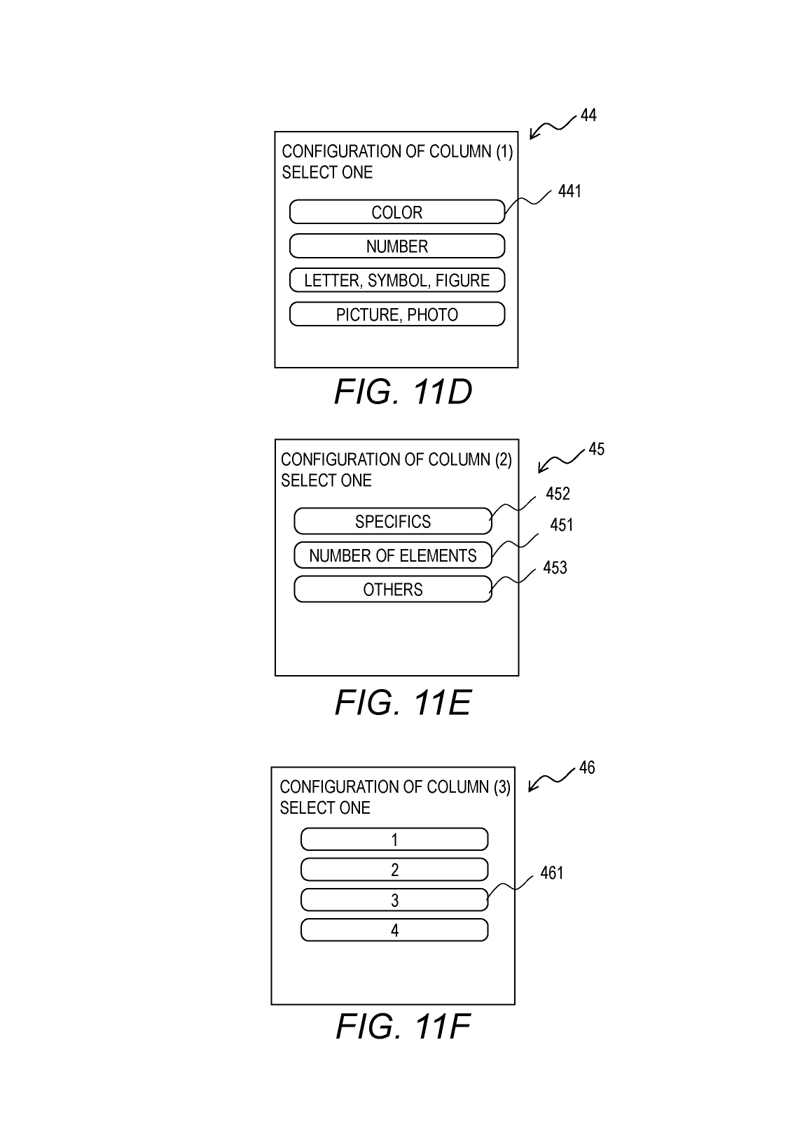

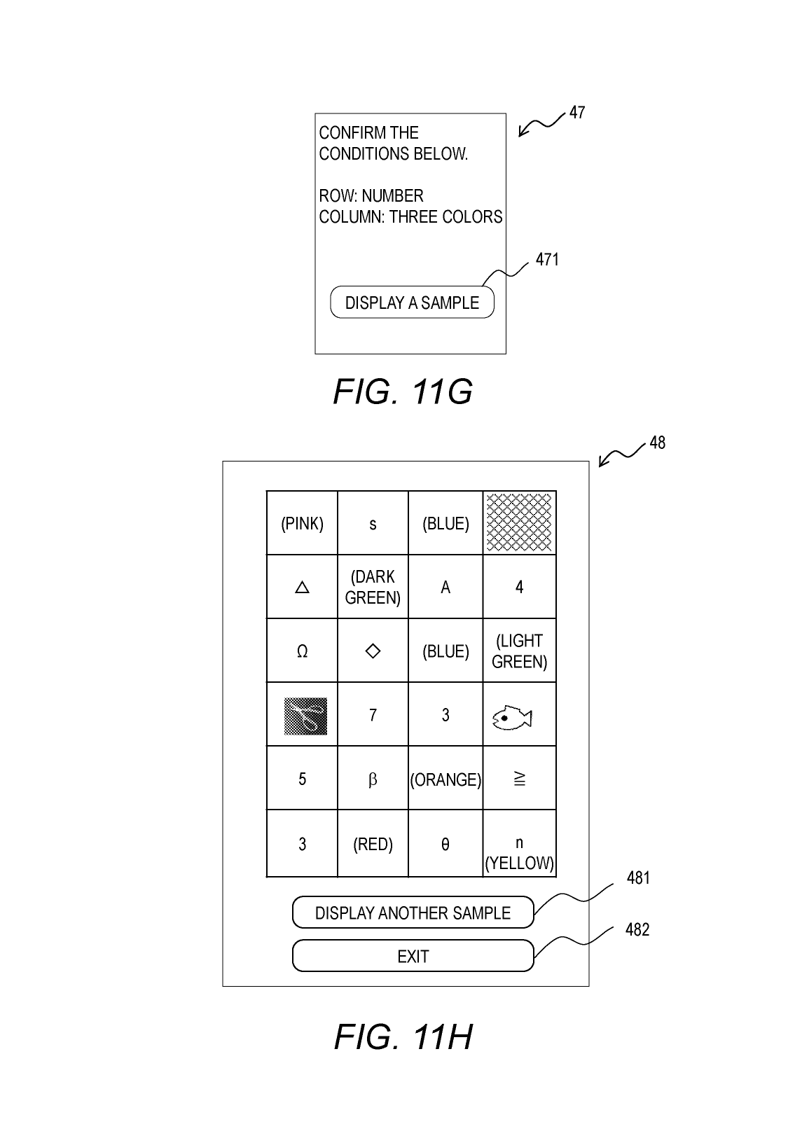

FIGS. 11A to 11H illustrate an example of a series of GUI images changing in configuring to-be selected image conditions. The GUI images are generated and presented by the user authentication related condition generation unit 111 and the user authentication related condition generation unit 111 stores definitions of conditions into the to-be selected image condition information 121 in accordance with the input onto the GUI images. Although the details of configuring authentication conditions are omitted here, the authentication conditions can be input by the user in accordance with the GUI images presented by the user authentication related condition generation unit 111 or preset in the system.

In the example described with reference to FIGS. 11A to 11H, it is assumed that the user configures (defines) a to-be selected image condition of “a number in a column including three colors”. This condition applies to the authentication images illustrated in FIGS. 5, 9A, and FIG. 9B.

FIGS. 11A to 11C are images to define to-be selected image conditions for the row including the to-be selected image. With reference to FIG. 11A, the user authentication related condition generation unit 111 displays a menu image 41 on the display device 15. The menu image 41 provides choices for a category to define a to-be selected image condition for the row including the to-be selected image. The condition for the row is only to include the to-be selected image. Accordingly, the button 411 of “NUMBER”, which is the category of the to-be selected image, is selected from this menu image 41.

FIG. 11B provides a menu image 42 to be displayed after the “NUMBER” button 411 is selected in the menu image 41 in FIG. 11A. The menu image 42 provides choices to define a condition about the selected images of “NUMBER”. There is no condition for the “NUMBER” of the to-be selected image and accordingly, the “OTHERS” button 421 is selected. In the case where a specific element or the number of elements for the “NUMBER” is to be specified, the other button 422 or 423 is selected.

FIG. 11C provides a menu image 43 to be displayed after the “OTHERS” button 421 is selected in the menu image 42 in FIG. 11B. The menu image 43 includes buttons to specify the conditions for the image of “NUMBER”, in this example, a “POSITION” button 432 to specify the position of the image. In this example, there is no condition for the position of the to-be selected image and accordingly, the “NOT SPECIFIED” button 431 is selected.

FIGS. 11D to 11F are images to define to-be selected image conditions for the column including the to-be selected image. The menu image 44 in FIG. 11D provides choices for a category to define a to-be selected image condition for the column. The to-be selected image conditions in this example include “a column including three colors”. Accordingly, the button 441 of “COLOR” is selected.

FIG. 11E provides a menu image 45 to be displayed after the “COLOR” button 441 is selected in the menu image 44 in FIG. 11D. The menu image 45 provides choices to define a condition for the selected images of “COLOR”. As described above, the to-be selected image conditions include a condition of “a column including three colors”. Accordingly, the “NUMBER OF ELEMENTS” button 451 is selected. In the case where the element of “COLOR” is specified, the “SPECIFICS” button 452 is selected. The “OTHERS” button 453 is the same as the “OTHERS” button 421 in the menu image 42.

FIG. 11F provides a menu image 46 to be displayed after the “NUMBER OF ELEMENTS” button 451 is selected in the menu image 45 in FIG. 11E. The menu image 46 provides choices for the number of elements to be displayed in the column. In this example, the “3” button 461 is selected.

FIG. 11G provides a GUI image 47 to be displayed after one of the buttons in the menu image 46 is selected. All information for the to-be selected image conditions have been specified. Accordingly, the GUI image 47 shows the configured (defined) to-be selected image conditions and a button 471 to show a sample of an authentication image to the user.

FIG. 11H provides a GUI image 48 to be displayed in response to the user selecting the button 471 with the input device 14. The GUI image 48 shows an example of an authentication image satisfying the configured to-be selected image conditions. The user authentication related condition generation unit 111 generates an authentication image in accordance with the to-be selected image conditions. When the button 481 is selected, the user authentication related condition generation unit 111 generates and displays another example of an authentication image. When the button 482 is selected, the processing to configure to-be selected image conditions is terminated.

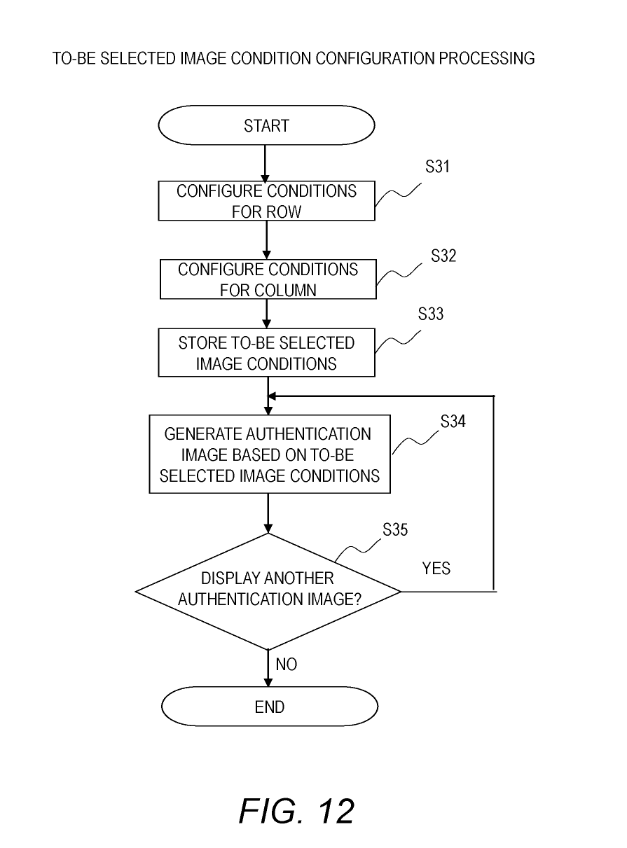

Next, processing of the user authentication related condition generation unit 111 is described. FIG. 12 is a flowchart of an example of the method of configuring to-be selected image conditions for the user authentication related condition generation unit 111. The description here is provided assuming that the authentication image is composed of a plurality of images disposed in a matrix and includes one to-be selected image.

First, the user authentication related condition generation unit 111 configures the conditions for the row including the to-be selected image in accordance with user input (S31). Next, the user authentication related condition generation unit 111 configures the conditions for the column including the to-be selected image in accordance with user input (S32). Next, the user authentication related condition generation unit 111 stores the configured to-be selected image conditions to the to-be selected image condition information 121 in the auxiliary storage device 13 (S33).

Next, the user authentication related condition generation unit 111 generates and displays an example of an authentication image satisfying the configured to-be selected image conditions in accordance with an instruction from the user (S34). If the user authentication related condition generation unit 111 receives an instruction to display another example of authentication image from the user (S35: YES), it generates and displays another example of an authentication image satisfying the configured to-be selected image conditions (S34). If the user authentication related condition generation unit 111 receives an instruction to terminate the to-be selected image condition configuration processing from the user (S35: NO), it terminates the processing.

Hereinafter, some examples of user authentication using an authentication image are described. A method of user authentication presents an authentication image that does not include a to-be selected image during presentation of a series of authentication images including a to-be selected image. This configuration increases the security. An example of the authentication image not including (excluding) a to-be selected image is an image such that the category of the to-be selected image 312 in FIG. 9A or 352 in FIG. 9B is changed from “letter” or “number” to a different category.

For example, the authentication condition determination unit 113 displays an “INPUT END” button together with an authentication image. If the “INPUT END” button is selected after some image is selected, the authentication condition determination unit 113 denies the authenticity of the user. If the “INPUT END” button is selected without any image being selected, the authentication condition determination unit 113 may determine that the user is legitimate or withhold the determination and present a new authentication image.

The authentication condition determination unit 113 can present an authentication image without a to-be selected image at any frequency. The frequency can be lower than the frequency of presenting an image including a to-be selected image. In an example, the authentication condition determination unit 113 randomly determines whether to include a to-be selected image periodically, every time, or randomly in presenting an authentication image. In another example, the authentication condition determination unit 113 periodically presents an authentication image without a to-be selected image.

Another method of user authentication using an authentication image displays an authentication image including a plurality of to-be selected images and determines that the user is legitimate if those to-be selected images are selected simultaneously. This configuration increases the security. For example, two to-be selected images are displayed in an authentication image and the authentication condition determination unit 113 determines that the user is legitimate if the two to-be selected images are selected simultaneously, and determines that the authentication is failed in the other cases.

Next, an example of hybrid authentication using an authentication image and a fingerprint is described. The user authentication device 1 includes a fingerprint authentication sensor. When the user places a finger on the display device, the fingerprint authentication sensor reads its fingerprint. The user authentication device 1 compares the read fingerprint with a registered user’s fingerprint to determine whether the user is a registered user.

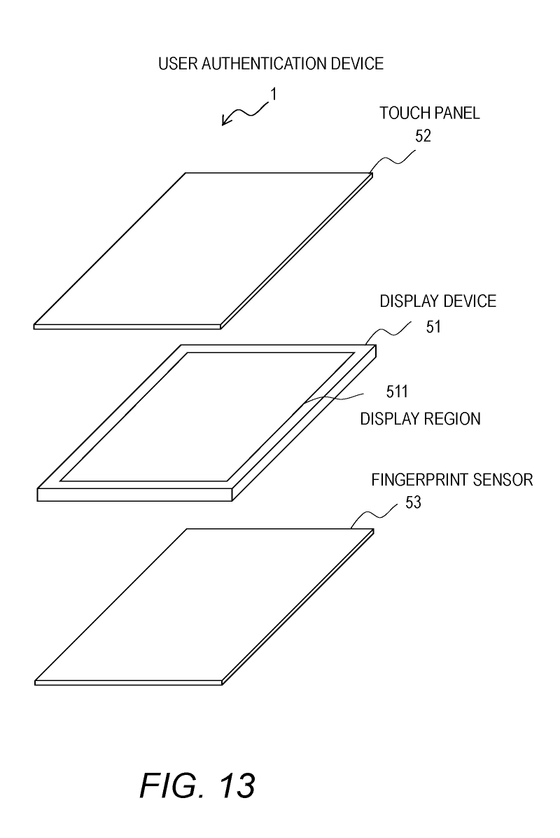

FIG. 13 illustrates a configuration example of a user authentication device 1 including a fingerprint sensor. The user authentication device 1 includes a display device 51 including a display region 511, a touch panel 52 in front of (on the viewing side of) the display device 51, and a fingerprint sensor 53 behind the display device 51. The fingerprint sensor 53 can be an optical fingerprint sensor or an ultrasonic fingerprint sensor. The type of the fingerprint sensor 53 and the position relative to the other devices in the layering direction of the fingerprint sensor 53 can be determined desirably.

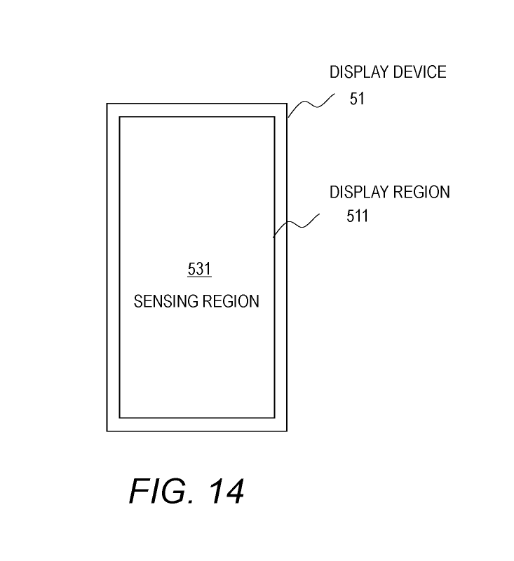

The sensing region of the fingerprint sensor 53 includes at least a part of the display region 511 of the display device 51; a to-be selected image is displayed in the region. The sensing region of the fingerprint sensor 53 can include the entire display region 511 of the display device 51. Then, a fingerprint can be recognized anywhere in the display region. FIG. 14 illustrates an example of the relation between the sensing region 531 of the fingerprint sensor 53 and the display region 511. The sensing region 531 coincides with the display region 511 in a planar view. The sensing region 531 can be larger than the display region 511.

The information on the user’s fingerprint can be stored in advance in the auxiliary storage device 13. The fingerprint sensor 53 reads the fingerprint of the finger in contact with the displayed authentication image and forwards the information on it to the arithmetic device 11. The authentication condition determination unit 113 compares the fingerprint information received from the fingerprint sensor 53 with the registered fingerprint information to determine whether it matches or mismatches the registered information.

If the to-be selected image is selected and also the fingerprint is a match, the authentication condition determination unit 113 determines that this user is legitimate. If either one is a mismatch, it determines that the user authentication is failed. In the case where the authentication conditions include a condition that a plurality of, for example two, to-be selected images are to be selected simultaneously, fingerprints of two fingers are registered in advance. The authentication condition determination unit 113 determines that the user is the registered user if the fingerprint information on two fingers received from the fingerprint sensor 53 matches the registered information. The number of kinds of the fingers to register the fingerprints can be equal to or more than the number of fingers to touch simultaneously.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A device to perform user authentication, the device comprising:
a controller; and
a display device,
wherein the controller is configured to display a user authentication image including a plurality of images on the display device,
wherein the plurality of images include a to-be selected image for user authentication,
wherein conditions for the user authentication include a condition that the to-be selected image is selected,
wherein the to-be selected image satisfies a predetermined to-be selected image condition, and
wherein the to-be selected image condition specifies a positional relation of the to-be selected image to a neighboring image different from the to-be selected image and satisfying a predetermined neighboring image condition.

2. The device according to claim 1,
wherein the plurality of images include a plurality of to-be selected images, and
wherein the conditions for the user authentication include a condition that the plurality of to-be selected images are selected.

3. The device according to claim 1, wherein the plurality of images are disposed in a matrix.

4. The device according to claim 1, wherein the controller is configured to randomly determine a position of the to-be selected image.

5. The device according to claim 1, wherein the controller is configured to randomly determine images different from the to-be selected image within a range satisfying the to-be selected image condition.

6. The device according to claim 1, wherein the controller is configured to include presenting a user authentication image that does not include the to-be selected image in a plurality of times of successive user authentication processing.

7. The device according to claim 1, further comprising:
a touch panel; and
a fingerprint sensor,
wherein the controller is configured to:
receive user input to the user authentication image through the touch panel; and
read a user’s fingerprint in the user input onto the touch panel, and
wherein the conditions for the user authentication include a condition that the read user’s fingerprint matches a fingerprint registered in advance.

8. A method for a device to perform user authentication, the method comprising:
displaying, by the device, a user authentication image including a plurality of images,
wherein the plurality of images include a to-be selected image for user authentication,
wherein conditions for the user authentication include a condition that the to-be selected image is selected,
wherein the to-be selected image satisfies a predetermined to-be selected image condition, and
wherein the to-be selected image condition specifies a positional relation of the to-be selected image to a neighboring image different from the to-be selected image and satisfying a predetermined neighboring image condition.
